(19) United States
(12) Patent Application Publication
(10) Pub. No.: US 2018/0045921 A1
(43) Pub. Date: Feb. 15, 2018

(54) IMAGING LENS AND IMAGE CAPTURING DEVICE

(71) Applicant: Nikon Corporation, Tokyo (JP)

(72) Inventors: Masato KUMAZAWA, Sagamihara-shi (JP); Katsuya WATANABE, Yokohama-shi (JP); Miwako YOSHIDA, Yokohama-shi (JP); Junya HAGIWARA, Chigasaki-shi (JP); Takashi KUSAKA, Yokohama-shi (JP); Atsushi SEKINE, Kasukabe-shi (JP)

(21) Appl. No.: 15/796,778

(22) Filed: Oct. 28, 2017

Related U.S. Application Data
(63) Continuation of application No. PCT/JP2015/002313, filed on May 1, 2015.

(51) Int. Cl. G02B 13/00; G02B 9/60

(52) U.S. Cl. CPC G02B 13/0045; G02B 9/60; G02B 7/021

(57) ABSTRACT

An imaging lens (PL) has an image surface (I) curved to have a concave surface facing an object and consists of, in order from the object along an optical axis (Ax): a front group (Ga) including four lenses (L1 to L4); and a back group (Gb) including a single lens (L5). The following conditional expression is satisfied.

0.25<Dab/TL<0.50

0.30<La/TL<0.55
where,
Dab denotes a distance between the front group (Ga) and the back group (Gb) on the optical axis,
La denotes a length of the front group (Ga) on the optical axis, and
TL denotes a total length of the imaging lens (PL) (a distance between a vertex of a lens surface closest to the object and an axial image point corresponding to an infinite distant object).

### RELATED APPLICATIONS

This is a continuation of PCT International Application No. PCT/JP2015/002313, filed on May 1, 2015, which is hereby incorporated by reference.

### TECHNICAL FIELD

The present invention relates to an imaging lens usable for an image capturing device embedded in a mobile terminal or the like.

### TECHNICAL BACKGROUND

Imaging lenses (see, for example, Patent Documents 1 and 2) used in small image capturing devices embedded in mobile terminals or the like are required to have high resolving power of about 1 to 2 μm on an image surface, due to development of image sensors with an increased number of pixels. The imaging lenses are also required to have a shorter total length due to ever increasing demand for thinner mobile terminals or the like. The high resolving power may be achieved by an imaging lens having an aspherical lens surface. Thus, almost all the lens surfaces of conventional imaging lenses used in small image capturing devices are aspherical. Another possible solution is to increase the number of lenses to achieve the imaging lens with high resolving power. Logically, the increased number of lenses simply leads to a larger space required for the lenses to be inserted, and thus results in a longer length of the entire imaging lens.

### PRIOR ARTS LIST

### Patent Document

Patent Document 1: WO2013/027641(A1)

Patent Document 2: Japanese Laid-Open Patent Publication No. 2015-22152(A)

### SUMMARY OF THE INVENTION

### Problems to be Solved by the Invention

As described above with reference to the conventional imaging lens, a solution for achieving an imaging lens having high imaging performance while having a shorter total length.

The present invention is made in view of the above, and an object of the present invention is to provide an imaging lens having a short total length and favorable imaging performance, and an image capturing device including the same.

### Means to Solve the Problems

To achieve the object described above, an imaging lens according to the present invention has an image surface curved to have a concave surface facing an object and consists of, in order from the object: a front group including four lenses; and a back group including a single lens, in which the following conditional expression is satisfied.

0.25<Dab/TL<0.50

0.30<La/TL<0.55

where,

Dab denotes a distance between the front group and the back group on the optical axis,

La denotes a length of the front group on the optical axis, and

TL denotes a total length of the imaging lens (a distance between a vertex of a lens surface closest to the object and an axial image point corresponding to an infinite distant object).

An image capturing device according to the present invention comprises: an image lens with which an image of an object is formed on an image capturing surface of an image sensor; and the image sensor configured to obtain the image of the object formed on the image capturing surface. The image capturing surface of the image sensor is curved to have a concave surface facing the object. The imaging lens has an image surface curved along the image capturing surface. The imaging lens is the above-described imaging lens.

### Advantageous Effects of the Invention

With the present invention, excellent imaging performance with a wide angle of view and high brightness can be achieved with an imaging lens having a small size with a short total length.

### BRIEF DESCRIPTION OF THE DRAWINGS

FIG. 1 is a diagram illustrating a lens configuration of an imaging lens according to Example 1.

FIG. 2 is graphs illustrating various aberrations of the imaging lens according to Example 1.

FIG. 3 is a diagram illustrating a lens configuration of an imaging lens according to Example 2.

FIG. 4 is graphs illustrating various aberrations of the imaging lens according to Example 2.

FIG. 5 is a diagram illustrating a lens configuration of an imaging lens according to Example 3.

FIG. 6 is graphs illustrating various aberrations of the imaging lens according to Example 3.

FIG. 7 is a diagram illustrating a lens configuration of an imaging lens according to Example 4.

FIG. 8 is graphs illustrating various aberrations of the imaging lens according to Example 4.

FIG. 9 is a diagram illustrating a lens configuration of an imaging lens according to Example 5.

FIG. 10 is graphs illustrating various aberrations of the imaging lens according to Example 5.

FIG. 11 is a diagram illustrating a lens configuration of an imaging lens according to Example 6.

FIG. 12 is graphs illustrating various aberrations of the imaging lens according to Example 6.

FIG. 13 is a diagram illustrating a lens configuration of an imaging lens according to Example 7.

FIG. 14 is graphs illustrating various aberrations of the imaging lens according to Example 7.

FIG. 15 is a cross-sectional view of an image capturing device.

### DESCRIPTION OF THE EMBODIMENTS

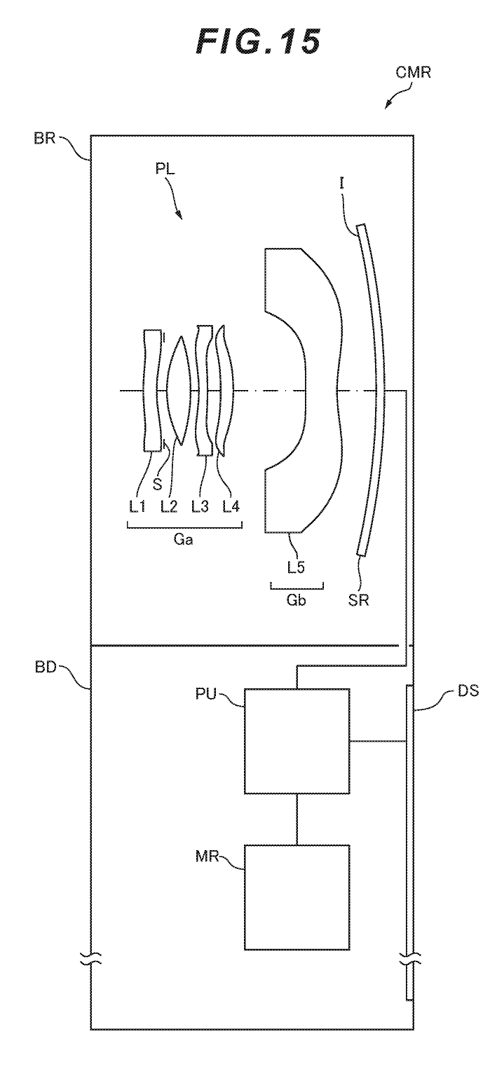

A preferred embodiment of the present application is described below with reference to the drawings. FIG. 15 illustrates an image capturing device CMR including an imaging lens according to the present application. Specifically, FIG. 15 is a cross-sectional view of the image capturing device CMR embedded in a mobile terminal or the like. The image capturing device CMR mainly includes: a barrel BR provided in a device main body BD of the mobile terminal or the like; an imaging lens PL contained and held in the barrel BR; an image sensor SR contained in the barrel BR; and a control unit PU contained in the device main body BD. With the imaging lens PL, an image of a subject (object) is formed on an image capturing surface of the image sensor SR.

The image sensor SR includes an image sensor such as a CCD or a CMOS, and is disposed along an image surface I of the imaging lens PL. The image sensor SR has a surface as an image capturing surface on which pixels (photoelectric conversion elements) are two-dimensionally formed. The image capturing surface of the image sensor SR is curved to have a concave surface facing the object. The imaging lens PL has the image surface I curved along the image capturing surface of the image sensor SR. For example, the image sensor SR has the image capturing surface as a spherical concave surface or an aspherical concave surface. The image sensor SR photoelectrically converts light from the subject, focused on the image capturing surface with the imaging lens PL, and outputs the resultant image data on the subject to the control unit PU or the like.

The control unit PU is electrically connected to: the image sensor SR; an I/O unit DS provided on an outer side of the device main body BD of the mobile terminal or the like; and a storage unit MR contained in the device main body BD. The I/O unit DS, including a touch panel and a liquid crystal panel, executes processing corresponding to an operation (such as an image capturing operation) of a user, displays the subject image obtained by the image sensor SR, or the other like processing. The storage unit MR stores data required for operations of the image sensor SR or the like, and the image data on the subject obtained by the image sensor SR. The control unit PU controls each of the image sensor SR, the I/O unit DS, the storage unit MR, or the like. The control unit PU can execute various types of image processing on the image data on the subject obtained by the image sensor SR.

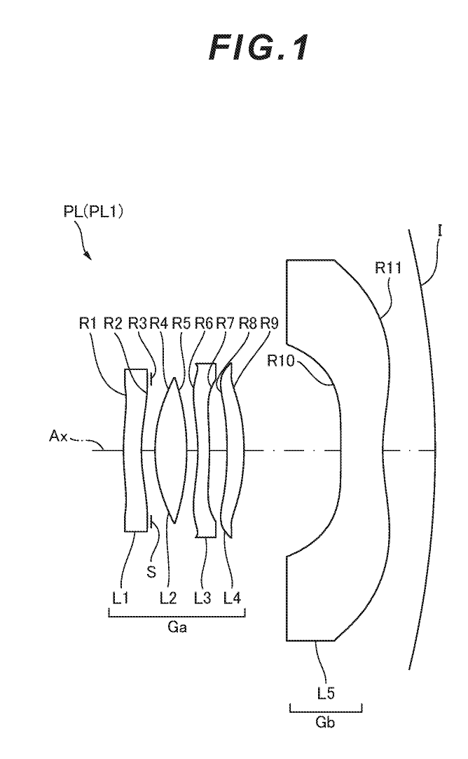

An imaging lens PL according to the present embodiment is described. For example, as illustrated in FIG. 1, the imaging lens PL according to the present embodiment includes in order from an object along an optical axis Ax: a front group Ga including four lenses L1 to L4; and a back group Gb including a single lens L5, and has the image surface I curved to have a concave surface facing the object. Specifically, the image surface I of the imaging lens PL is curved more largely toward the object, as it gets closer to a peripheral portion from the optical axis Ax. The imaging lens PL having the configuration described above satisfies conditions indicated by the following conditional expressions (1) and (2).

0.25<Dab/TL<0.50 (1)

0.30<La/TL<0.55 (2)

where,

Dab denotes a distance between the front group Ga and the back group Gb on the optical axis,

La denotes a length of the front group Ga on the optical axis, and

TL denotes a total length of the imaging lens PL (a distance between a vertex of a lens surface closest to the object and an axial image point corresponding to an infinite distant object).

In the present embodiment, the image surface I of the imaging lens PL is curved to have the concave surface facing the object, and thus a load for correcting curvature of field can be reduced. Thus, favorable imaging performance can be achieved with a smaller number of lenses and thus with a shorter total length of the imaging lens PL. With the conditions indicated by the conditional expressions (1) and (2), excellent imaging performance with a wide angle of view and high brightness can be achieved with the imaging lens PL having a small size with a short total length.

The conditional expression (1) is for appropriately setting the total length TL of the imaging lens PL. A condition with a value that is smaller than the lower limit value of the conditional expression (1) leads to an excessively small distance Dab between the front group Ga and the back group Gb, resulting in a need for a long back focus for maintaining a total length of the imaging lens PL long enough to successfully correct aberration. Thus, with such a condition, the back group Gb has a limited curvature of field correction effect. Thus, the curvature of the image capturing surface of the image sensor SR needs to be increased. All things considered, the condition results in an increase in the manufacturing cost of the image sensor SR, and thus is unfavorable. A condition with a value that is larger than the upper limit value of the conditional expression (1) leads to an excessively large distance Dab between the front group Ga and the back group Gb, which is likely to lead to a larger total length TL of the imaging lens PL and results in an insufficient back focus, and thus is unfavorable.

To guarantee the effects of the present embodiment, the lower limit value of the conditional expression (1) is preferably set to be 0.27. To guarantee the effects of the present embodiment, the upper limit value of the conditional expression (1) is preferably set to be 0.41.

The conditional expression (2) is for appropriately setting the length La of the front group Ga. A condition with a value that is smaller than the lower limit value of the conditional expression (2) leads to an excessively small length La of the front group Ga, resulting in an excessively small thickness at the center and the edge of each of the lenses in the front group Ga, rendering manufacturing of the lenses in the front group Ga difficult, and thus is unfavorable. A condition with a value that is larger than the upper limit value of the conditional expression (2) leads to an excessively large length La of the front group Ga, resulting in a large distance between the image-side lens in the front group Ga and the aperture stop S. This results in a limited spherical aberration correction effect. Thus, with such a condition, the F number of the imaging lens PL is difficult to maintain at a value indicating a high brightness.

To guarantee the effects of the present embodiment, the lower limit value of the conditional expression (2) is preferably set to be 0.38. To guarantee the effects of the present embodiment, the upper limit value of the conditional expression (2) is preferably set to be 0.54 or below. To guarantee the effects of the present embodiment, the upper limit value of the conditional expression (2) is more preferably set to be below 0.50.

The front group Ga includes: a first lens L1 having positive or negative refractive power; a second lens L2 having positive refractive power; a third lens L3 having negative refractive power; and a fourth lens L4 having positive refractive power which are disposed in order from the object along the optical axis Ax. The back group Gb includes a fifth lens L5 having negative refractive power. This configuration more effectively guarantees favorable imaging performance with a shorter length of the entire imaging lens PL. As in the examples described below, the specific lens configuration of the groups is not limited to the configuration in which the front group Ga includes the four lenses L1 to L4 and the back group Gb includes a single lens L5. For example, one or both of the front group Ga and the back group Gb may further include one or a plurality of lenses.

The imaging lens PL having the configuration described above preferably satisfies a condition indicated by the following conditional expression (3).

0.85<fa/f<1.10 (3)

where,

fa denotes a focal length of the front group Ga, and

f denotes a focal length of the imaging lens PL.

The conditional expression (3) is for appropriately setting the focal length fa of the front group Ga. A condition with a value that is smaller than the lower limit value of the conditional expression (3) leads to an excessively small focal length fa of the front group Ga, rendering the correction of coma aberration corresponding to a peripheral image height difficult. Furthermore, the negative refractive power of the back group Gb needs to be increased to achieve a certain back focus, leading to excessively large incident angle of a flux of light incident on the image sensor SR, resulting in dimming at the peripheral portion. A condition with a value that is larger than the upper limit value of the conditional expression (3) leads to an excessively large focal length fa of the front group Ga. Thus, the negative refractive power of the back group Gb needs to be reduced to achieve a short total length of the imaging lens PL. This results in the back group Gb with a limited curvature of field correction effect. Thus, such a condition leads to a need for increasing a curvature of the image capturing surface of the image sensor SR, resulting in a larger manufacturing cost of the image sensor SR, and thus is unfavorable.

To guarantee the effects of the present embodiment, the upper limit value of the conditional expression (3) is preferably set to be 0.95.

The imaging lens PL having the configuration described above preferably satisfies a condition indicated by the following conditional expression (4).

0.7<f12/fa<1.9 (4)

where,

f12 denotes a combined focal length of the first lens L1 and the second lens L2, and

fa denotes the focal length of the front group Ga.

The conditional expression (4) is for appropriately setting the combined focal length f12 of the first lens L1 and the second lens L2. A condition with a value that is smaller than the lower limit value of the conditional expression (4) leads to an excessively small combined focal length f12 of the first lens L1 and the second lens L2, resulting in a need for increasing the negative refractive power of the third lens L3 on the image side in the front group Ga to achieve a certain back focus. This results in large refraction of light flux, emitted from the third lens L3, at the peripheral image height, rendering the correction of the coma aberration at the peripheral image height difficult. Thus, the condition results in decrease in peripheral light quantity. A condition with a value that is larger than the upper limit value of the conditional expression (4) leads to an excessively large combined focal length f12 of the first lens L1 and the second lens L2. Therefore it is difficult to put lenses having large negative refractive power in the third to the fifth lenses L3 to L5 on the image side in order to make the total length of the imaging lens PL short. Thus, such a condition leads to a limited curvature of field correction effect, resulting in a need to increase the curvature of the image capturing surface of the image sensor SR. Thus, the condition results in an increase in the manufacturing cost of the image sensor SR, and thus is unfavorable.

To guarantee the effects of the present embodiment, the lower limit value of the conditional expression (4) is preferably set to be 0.85. To guarantee the effects of the present embodiment, the upper limit value of the conditional expression (4) is preferably set to be 1.15.

The imaging lens PL having the configuration described above preferably satisfies a condition indicated by the following conditional expression (5).

−0.5<ψ34/ψ<0.5 (5)

where,

ψ34 denotes combined refractive power of the third lens L3 and the fourth lens L4, and

ψ denotes refractive power of the imaging lens PL.

The conditional expression (5) is for appropriately setting the combined refractive power ψ34 of the third lens L3 and the fourth lens L4. A condition with a value that is smaller than the lower limit value of the conditional expression (5) leads to large refraction of light flux, emitted from the fourth lens L4, at the peripheral image height when the combined refractive power ψ34 of the third lens L3 and the fourth lens L4 has an excessively large negative value, rendering the correction of the coma aberration corresponding to the peripheral image height difficult. Thus, the condition results in decreased in the peripheral light quantity. A condition with a value that is larger than the upper limit value of the conditional expression (5) leads to a need for arranging the back group Gb to be close to the front group Ga to compensate for an insufficient back focus when the combined refractive power ψ34 of the third lens L3 and the fourth lens L4 has an excessively large positive value, resulting in a small curvature of field correction effect of the back group Gb. Thus, such a condition leads to a need for increasing a curvature of the image capturing surface of the image sensor SR, resulting in a larger manufacturing cost of the image sensor SR, and thus is unfavorable.

To guarantee the effects of the present embodiment, the lower limit value of the conditional expression (5) is preferably set to be −0.1. To guarantee the effects of the present embodiment, the upper limit value of the conditional expression (5) is preferably set to be 0.35.

The imaging lens PL having the configuration described above preferably satisfies a condition indicated by the following conditional expression (6).

−0.8<ψ34/ψ5<1.5 (6)

where,

ψ34 denotes the combined refractive power of the third lens L3 and the fourth lens L4, and

ψ5 denotes refractive power of the fifth lens L5.

The conditional expression (6) is for appropriately setting a ratio between the combined refractive power ψ34 of the third lens L3 and the fourth lens L4 and the refractive power ψ5 of the fifth lens L5. A condition with a value that is smaller than the lower limit value of the conditional expression (6) leads to a need for arranging the back group Gb to be close to the front group Ga to compensate for an insufficient back focus when the combined refractive power ψ34 of the third lens L3 and the fourth lens L4 has an excessively large positive value, resulting in the back group Gb (the fifth lens L5) with a limited curvature of field correction effect. When the negative refractive power ψ5 of the fifth lens L5 is excessively small, the fifth lens L5 has a limited curvature of field correction effect. Thus, such a condition leads to a need for increasing a curvature of the image capturing surface of the image sensor SR, resulting in a larger manufacturing cost of the image sensor SR, and thus is unfavorable. A condition with a value that is larger than the upper limit value of the conditional expression (6) leads to large refraction of light flux, emitted from the fourth lens L4, at the peripheral image height when the combined refractive power ψ34 of the third lens L3 and the fourth lens L4 has an excessively large negative value, rendering the correction of the coma aberration corresponding to the peripheral image height difficult. Thus, the condition results in decrease in the peripheral light quantity.

To guarantee the effects of the present embodiment, the lower limit value of the conditional expression (6) is preferably set to be −0.4. To guarantee the effects of the present embodiment, the upper limit value of the conditional expression (6) is preferably set to be 0.2.

The imaging lens PL having the configuration described above preferably satisfies a condition indicated by the following conditional expression (7).

0.03<−SAG/Y<0.30 (7)

where,

Y denotes a maximum image height of the imaging lens PL, and

SAG denotes an amount of curvature of the image surface I in an optical axis direction at the maximum image height.

The conditional expression (7) is for setting an appropriate amount of curvature of the image surface I. The amount of curvature SAG of the image surface I in the optical axis direction at the maximum image height is the amount of curvature in the optical axis direction of the image surface I with respect to a tangential plane at a position intersecting with the optical axis Ax, with a direction from the object side toward the image side being a positive direction. A condition with a value that is smaller than the lower limit value of the conditional expression (7) leads to an excessively small amount of curvature of the image surface I. Thus, a large load is imposed on the back group Gb for correcting the curvature of field, and thus the back group Gb needs to have a lens surface with a wavy undulating shape. Thus, such a condition renders the manufacturing of the lens in the back group Gb difficult, resulting in a high manufacturing cost of the imaging lens PL, and thus is unfavorable. A condition with a value that is larger than the upper limit value of the conditional expression (7) leads to an excessively large amount of curvature of the image surface I, rendering the manufacturing of the image sensor SR difficult, resulting in a high manufacturing cost of the image sensor SR, and thus is unfavorable.

In the imaging lens PL having such a configuration, the four lenses in the front group Ga and the single lens in the back group Gb preferably include a set of lenses, including a positive lens and a negative lens disposed to an image side of the positive lens, satisfying the following conditional expressions (8) and (9).

−1.0<(Rpa+Rpb)/(Rpa−Rpb)<0.5 (8)

(Rna+Rnb)/(Rna−Rnb)<0.1 (9)

where,

Rpa denotes a radius of curvature of an object-side lens surface of the positive lens,

Rpb denotes a radius of curvature of an image-side lens surface of the positive lens,

Rna denotes a radius of curvature of an object-side lens surface of the negative lens, and

Rnb denotes a radius of curvature of an image-side lens surface of the negative lens.

The conditional expressions (8) and (9) are for appropriately setting the shape of the set of lenses including the positive lens and the negative lens disposed close to the aperture stop S. A condition with a value that is smaller than the lower limit value of the conditional expression (8) leads to a shape of the positive lens largely different from a shape with which the spherical aberration can be successfully corrected, rendering the correction of spherical aberration difficult. A condition with a value that is larger than the upper limit value of the conditional expression (8) also leads to a shape of the positive lens largely different from a shape with which the spherical aberration can be successfully corrected, rendering the correction of spherical aberration difficult.

A condition with a value that is larger than the upper limit value of the conditional expression (9) leads to a radius of curvature of the image-side lens surface of the negative lens that is excessively smaller than a radius of curvature of the object-side lens surface of the negative lens. As a result, an upper light flux, in the light flux at the peripheral image height, is largely refracted by the image-side lens surface with a passage portion more separated from the optical axis Ax than that of the object-side lens surface in the negative lens, rendering the correction of the coma aberration corresponding to the peripheral image height difficult. Thus, the condition results in decrease in the peripheral light quantity.

To guarantee the effects of the present embodiment, the lower limit value of the conditional expression (8) is preferably set to be −0.5. To guarantee the effects of the present embodiment, the upper limit value of the conditional expression (8) is preferably set to be 0.25. To guarantee the effects of the present embodiment, the lower limit value of the conditional expression (9) is preferably set to be −3.5.

With the present embodiment described above, the imaging lens PL and the image capturing device CMR having excellent imaging performance with a wide angle of view and high brightness while having a small size with a short total length can be achieved. In the embodiment described above, the image surface I has a curved shape to have a concave surface facing the object as illustrated in the figures referred to in Examples described below. The curved shape in a spherical shape is effective in terms of manufacturing, but is not limited to the spherical shape, and an aspherical concave surface may be employed.

### EXAMPLES

### Example 1

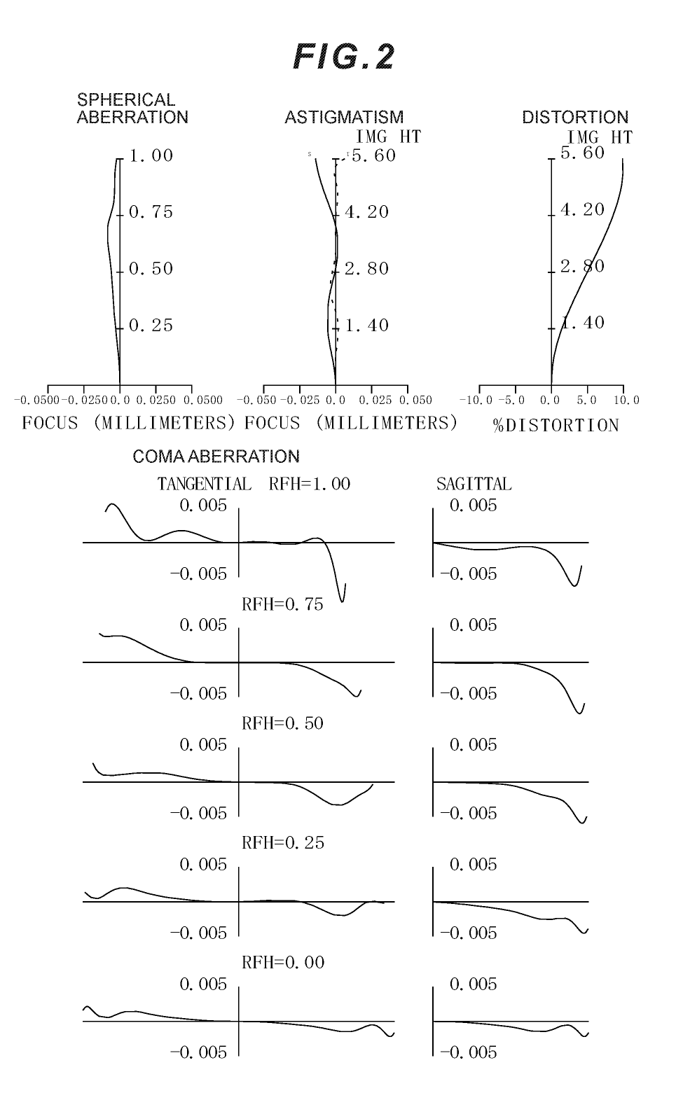

Examples according to the present application are described with reference to the drawings. First of all, Example 1 of the present application is described with reference to FIG. 1 and FIG. 2 and Table 1. FIG. 1 is a diagram illustrating a lens configuration of an imaging lens PL (PL1) according to Example 1. The imaging lens PL1 according to Example 1 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL1. Both side lens surfaces of the fifth lens L5 are aspherical surfaces.

Table 1 to Table 7 described below are tables illustrating specification values of imaging lenses according to Example 1 to Example 7. In the tables, [Overall specifications] includes values of the imaging lens PL such as: a focal length f; an F number Fno; half angle of view ω; a maximum image height Y; the total length TL (a distance between a vertex of a lens surface closest to the object and an axial image point corresponding to an infinite distant object); and the amount of curvature of the image surface I in an optical axis direction at a maximum image height. In the tables, [Lens specifications] includes: a first column (surface number) indicating the order of a lens surface from the object; a second column R indicating a radius of curvature of the lens surface; a third column D indicating a distance to the next lens surface on the optical axis; a fourth column nd indicating a refractive index with respect to a d-line (wavelength λ=587.6 nm); and a fifth column νd indicating an Abbe number with respect to the d-line (wavelength λ=587.6 nm). A mark * on the right of the first column (surface number) indicates that the lens surface is an aspherical surface. A radius of curvature “∞” indicates a flat surface, and a refractive index of air nd=1.000000 is omitted. A corresponding value of each conditional expression is written in [Conditional expression corresponding value].

An aspherical coefficient in [Aspherical data] is represented by the following formula (A), where Z denotes a distance (sag) from a lens surface vertex in the optical axis direction, h denotes the distance from the optical axis Ax, c denotes a curvature (reciprocal of the radius of curvature), K denotes a Korenich constant, and An denotes an nth (n=4, 6, 8, 10, 12, or 14) aspherical coefficient. In each Example, a secondary aspherical coefficient A2 is 0, and is omitted. In [Aspherical data] “E-n” represents “×10⁻ⁿ”.

Z=(c×h²)/[1+{1−(1+x)×c²×h²}^{1/2}]+A4×h⁴+A6×h⁶+A8×h⁸+A10×h¹⁰+A12×h¹²+A14×h¹⁴ (A)

The focal length f, the radius of curvature R, and the other units of length described below as the specification values, which are generally described with “mm” unless otherwise noted should not be construed in a limiting sense because the optical system proportionally expanded or reduced can have similar or the same optical performance. In Example 2 to Example 7 described below, the same reference signs as in this Example are used.

In Table 1 below, specification values in Example 1 are listed. The radii of curvature R of 1st to 11th surfaces in Table 1 respectively correspond to reference numerals R1 to R11 denoting 1st to 11th surfaces in FIG. 1. In Example 1, the 1st and 2nd surfaces and the 4th to 11th surfaces are aspherical lens surfaces.

TABLE 1
[Overall specifications]

| | |
|---|---|
| f | 6.511 |
| Fno | 2.0 |
| ω | 42.06° |
| Y | 5.6 |
| TL | 7.928 |
| SAG | −0.675 |

[Lens specifications]

| Surface | | | | |
|---|---|---|---|---|
| number | R | D | nd | νd |
| Object | ∞ | ∞ | | |
| surface | | | | |
| 1* | 6.06698 | 0.46046 | 1.63550 | 23.89 |
| 2* | 4.29845 | 0.25117 | | |
| 3 | ∞ | 0.10000 | | (Aperture stop) |
| 4* | 3.70703 | 0.81512 | 1.53460 | 56.27 |
| 5* | −5.38073 | 0.28281 | | |
| 6* | −5.19274 | 0.30000 | 1.63970 | 23.52 |
| 7* | −9.96852 | 0.45129 | | |
| 8* | −11.47009 | 0.43581 | 1.53500 | 55.73 |
| 9* | −5.99175 | 2.49001 | | |
| 10* | 147.49381 | 1.07752 | 1.53500 | 55.73 |
| 11* | 5.11029 | 1.34761 | | |
| Image | −23.57183 | | | |
| surface | | | | |

### [Aspherical Data]

### 1st Surface

x=0.000000, A4=−2.298845E-02, A6=−3.806620E-03, A8=1.346565E-03 A10=−1.520254E-04, A12=1.659247E-05, A14=−1.888448E-06

### 2nd Surface

x=0.000000, A4=−1.939229E-02, A6=−6.787089E-03, A8=2.668099E-03 A10=−3.889022E-04, A12=4.754067E-05, A14=−4.958172E-06

### 4th Surface

x=0.000000, A4=7.928330E-03, A6=−3.441098E-03, A8=5.793772E-04 A10=−1.081798E-04, A12=−2.674040E-05, A14=9.494537E-06

### 5th Surface

x=0.000000, A4=1.649361E-03, A6=2.012966E-03, A8=−9.364378E-04 A10=5.131411E-05, A12=8.720129E-06, A14=2.479313E-06

### 6th Surface

x=0.000000, A4=6.900347E-03, A6=1.234964E-02, A8=−2.924439E-03 A10=−6.895615E-05, A12=1.795145E-04, A14=−2.635131E-05

### 7th Surface

x=0.000000, A4=2.813963E-03, A6=1.510788E-02, A8=−2.832353E-03 A10=2.988135E-04, A12=2.602099E-05, A14=−1.160056E-05

### 8th Surface

x=0.000000, A4=−2.790332E-02, A6=8.110374E-03, A8=−8.567061E-05 A10=−1.496320E-04, A12=9.785314E-05, A14=−1.266169E-05

### 9th Surface

x=0.000000, A4=−1.825223E-02, A6=3.841026E-03, A8=−2.153898E-04 A10=1.750593E-04, A12=−3.852294E-05, A14=6.553342E-06

### 10th Surface

x=0.000000, A4=−2.703998E-02, A6=2.632613E-04, A8=2.771417E-04 A10=−8.978915E-05, A12=1.101376E-05, A14=−6.195389E-07

### 11th Surface

x=0.000000, A4=−2.001895E-02, A6=1.711622E-03, A8=−1.269262E-04 A10=6.049089E-06, A12=−1.661971E-07, A14=1.879388E-09

### [Conditional Expression Corresponding Value]

Dab/TL=0.314 Conditional expression (1)

La/TL=0.391 Conditional expression (2)

fa/f=0.882 Conditional expression (3)

f12/fa=0.890 Conditional expression (4)

ψ34/ψ=−0.066 Conditional expression (5)

ψ34/ψ5=0.101 Conditional expression (6)

−SAG/Y=0.121 Conditional expression (7)

(Rpa+Rpb)/(Rpa−Rpb)=−0.184 Conditional expression (8)

(Rna+Rnb)/(Rna−Rnb)=−3.175 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 2 is graphs illustrating various aberrations of the imaging lens PL1 according to Example 1. In an aberration graph illustrating astigmatism, a solid line represents a sagittal image surface, and a broken line represents a meridional image surface. In an aberration graph illustrating the coma aberration, RFH denotes Relative Field Height. The description on the aberration graphs similarly applies to the other Examples.

It can be seen in the aberration graphs that in Example 1, various aberrations are successfully corrected and excellent imaging performance is achieved with F number of 2.0 indicating a high brightness and a half angle of view of 42° that can be regarded as a wide angle of view. All things considered, the excellent imaging performance of the image capturing device CMEt including the imaging lens PL1 according to Example 1 can be guaranteed.

### Example 2

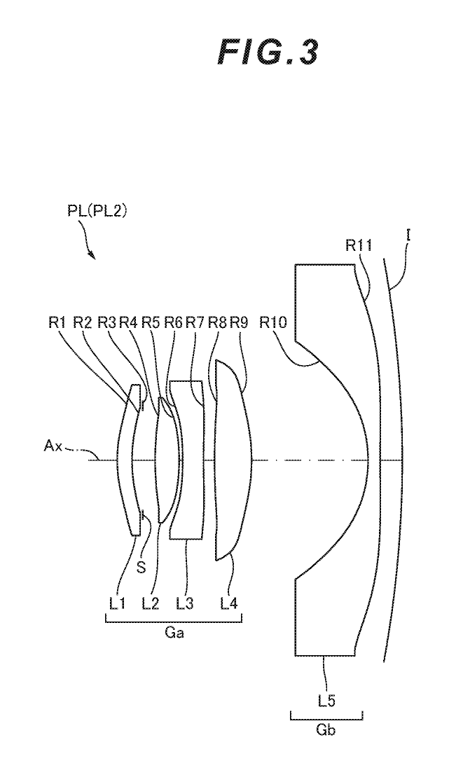

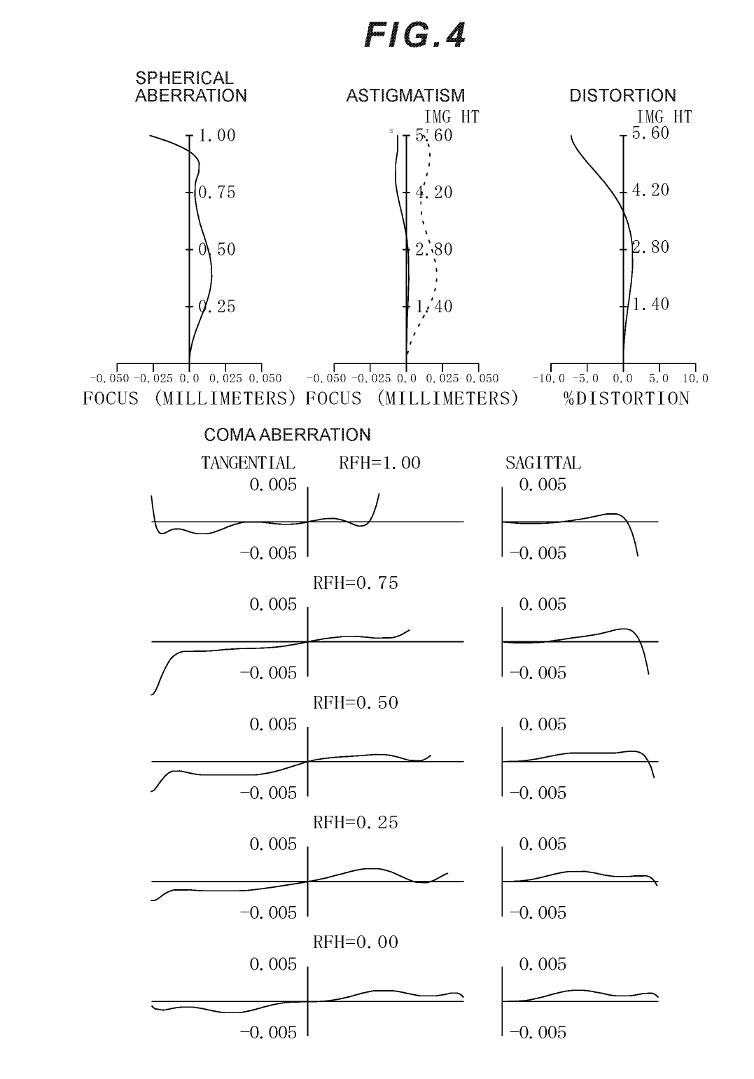

Next, Example 2 according to the present application is described with reference to FIG. 3 and FIG. 4 and Table 2. FIG. 3 is a diagram illustrating a lens configuration of an imaging lens PL (PL2) according to Example 2. The imaging lens PL2 according to Example 2 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having positive refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL2. Both side lens surfaces of the fifth lens L5 are aspherical surfaces.

In Table 2 below, specification values in Example 2 are listed. The radii of curvature R of 1st to 11th surfaces in Table 2 respectively correspond to reference numerals R1 to R11 denoting 1st to 11th surfaces in FIG. 3. In Example 2, the 1st and 2nd surfaces and the 4th to 11th surfaces are aspherical lens surfaces.

TABLE 2
[Overall specifications]

| | |
|---|---|
| f | 6.012 |
| Fno | 2.0 |
| ω | 48.45° |
| Y | 5.6 |
| TL | 7.996 |
| SAG | −0.518 |

[Lens specifications]

| Surface | | | | |
|---|---|---|---|---|
| number | R | D | nd | νd |
| Object | ∞ | ∞ | | |
| surface | | | | |
| 1* | 3.60375 | 0.41564 | 1.53460 | 56.27 |
| 2* | 4.16479 | 0.29988 | | |
| 3 | ∞ | 0.34839 | | (Aperture stop) |
| 4* | 7.95242 | 0.67192 | 1.53460 | 56.27 |
| 5* | −5.98506 | 0.10000 | | |
| 6* | −9.59741 | 0.58668 | 1.63970 | 23.52 |
| 7* | 16.63470 | 0.30653 | | |
| 8* | 16.40075 | 1.04240 | 1.53500 | 55.73 |
| 9* | −4.83346 | 3.26645 | | |
| 10* | −3.59471 | 0.34000 | 1.53500 | 55.73 |
| 11* | 72.67639 | 0.61846 | | |
| Image | −30.51089 | | | |
| surface | | | | |

### [Aspherical Data]

### 1st Surface

x=0.000000, A4=−1.037941E-02, A6=−2.029760E-03, A8=−5.079460E-04 A10=2.165557E-04, A12=2.972083E-05, A14=−8.338239E-06

### 2nd Surface

x=0.000000, A4=−6.439805E-03, A6=−3.624172E-03, A8=9.273464E-04 A10=1.552310E-04, A12=−7.518774E-05, A14=4.631958E-05

### 4th Surface

x=0.000000, A4=5.235103E-04, A6=−1.734894E-03, A8=−2.312747E-04 A10=3.764129E-05, A12=−9.629463E-05, A14=2.968263E-05

### 5th Surface

x=0.000000, A4=−1.125825E-02, A6=−5.446069E-03, A8=9.413400E-04 A10=−1.838237E-04, A12=2.689155E-05, A14=−5.860956E-06

### 6th Surface

x=0.000000, A4=−2.245910E-02, A6=2.247768E-05, A8=3.469439E-04 A10=2.982258E-04, A12=−5.334448E-05, A14=1.373145E-06

### 7th Surface

x=0.000000, A4=−1.661618E-02, A6=1.598011E-03, A8=1.924405E-04 A10=−2.444460E-05, A12=−1.164370E-05, A14=1.901876E-06

### 8th Surface

x=0.000000, A4=−1.447034E-03, A6=−2.180986E-04, A8=−8.957858E-05 A10=1.426290E-05, A12=−2.246623E-06, A14=−8.594991E-07

### 9th Surface

x=0.000000, A4=6.374166E-03, A6=3.236499E-04, A8=1.726880E-05 A10=−1.281063E-05, A12=−8.284675E-07, A14=−1.033536E-07

### 10th Surface

x=0.000000, A4=−4.676201E-03, A6=5.279003E-04, A8=−2.660978E-05 A10=2.724921E-06, A12=8.341161E-09, A14=−2.661733E-09

### 11th Surface

x=0.000000, A4=−2.689705E-03, A6=1.056793E-04, A8=−4.053882E-06 A10=1.046981E-07, A12=−1.422275E-09, A14=1.906645E-11

### [Conditional Expression Corresponding Value]

Dab/TL=0.409 Conditional expression (1)

La/TL=0.472 Conditional expression (2)

fa/f=0.885 Conditional expression (3)

f12/fa=1.109 Conditional expression (4)

ψ34/ψ=−0.305 Conditional expression (5)

ψ34/ψ5=−0.324 Conditional expression (6)

−SAG/Y=0.324 Conditional expression (7)

(Rpa+Rpb)/(Rpa−Rpb)=−0.141 Conditional expression (8)

(Rna+Rnb)/(Rna−Rnb)=−0.268 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 4 is graphs illustrating various aberrations of the imaging lens PL2 according to Example 2. It can be seen in the aberration graphs that in Example 2, various aberrations are successfully corrected and excellent imaging performance is achieved with F number of 2.0 indicating a high brightness and a half angle of view exceeding 48° that can be regarded as a wide angle of view. All things considered, the excellent imaging performance of the image capturing device CMR including the imaging lens PL2 according to Example 2 can be guaranteed.

### Example 3

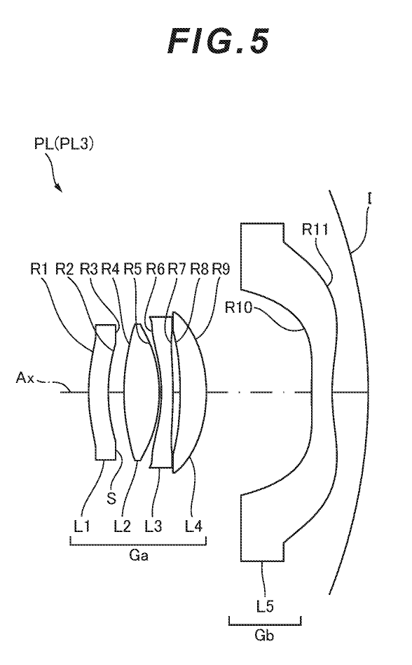

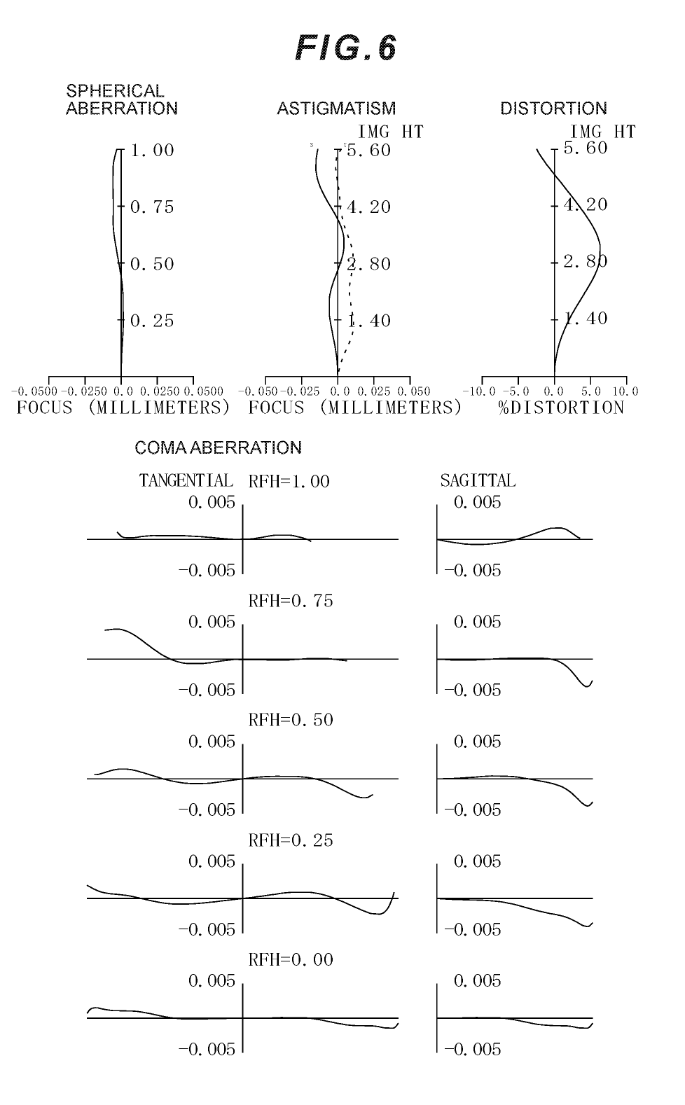

Next, Example 3 according to the present application is described with reference to FIG. 5 and FIG. 6 and Table 3. FIG. 5 is a diagram illustrating a lens configuration of an imaging lens PL (PL3) according to Example 3. The imaging lens PL3 according to Example 3 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL3. Both side lens surfaces of the fifth lens L5 are aspherical surfaces.

In Table 3 below, specification values in Example 3 are listed. The radii of curvature R of 1st to 11th surfaces in Table 3 respectively correspond to reference numerals R1 to R11 denoting 1st to 11th surfaces in FIG. 5. In Example 3, the 1st and 2nd surfaces and the 4th to 11th surfaces are aspherical lens surfaces.

TABLE 3
[Overall specifications]

| | |
|---|---|
| f | 5.609 |
| Fno | 2.0 |
| ω | 51.77° |
| Y | 5.6 |
| TL | 7.808 |
| SAG | −1.085 |

[Lens specifications]

| Surface | | | | |
|---|---|---|---|---|
| number | R | D | nd | νd |
| Object | ∞ | ∞ | | |
| surface | | | | |
| 1* | 4.64441 | 0.54843 | 1.63970 | 23.52 |
| 2* | 4.37340 | 0.20805 | | |
| 3 | ∞ | 0.22981 | | (Aperture stop) |
| 4* | 5.70254 | 0.98719 | 1.53500 | 55.73 |
| 5* | −3.72046 | 0.06120 | | |
| 6* | −4.01508 | 0.32000 | 1.63970 | 23.52 |
| 7* | −11.64067 | 0.20147 | | |
| 8* | −10.52502 | 0.73400 | 1.53500 | 55.73 |
| 9* | −4.00660 | 2.93693 | | |
| 10* | 17.17541 | 0.57293 | 1.53500 | 55.73 |
| 11* | 5.30981 | 1.00789 | | |
| Image | −15.00000 | | | |
| surface | | | | |

### [Aspherical Data]

### 1st Surface

x=0.000000, A4=−7.494419E-03, A6=−1.307114E-03, A8=−8.652404E-05 A10=8.857996E-05, A12=−1.779677E-05, A14=−2.461760E-07

### 2nd Surface

x=0.000000, A4=−1.908329E-03, A6=−1.745243E-03, A8=5.830655E-04 A10=1.321530E-05, A12=−1.559836E-05, A14=6.562138E-06

### 4th Surface

x=0.000000, A4=1.864114E-03, A6=−7.827769E-04, A8=−3.314667E-04 A10=−7.369649E-05, A12=1.290904E-05, A14=9.728552E-06

### 5th Surface

x=0.000000, A4=1.625439E-03, A6=−3.054751E-03, A8=4.172513E-04 A10=−2.348160E-05, A12=4.529568E-05, A14=−5.625603E-06

### 6th Surface

x=0.000000, A4=1.155928E-02, A6=−8.982120E-04, A8=1.680558E-04 A10=2.658503E-04, A12=1.696269E-05, A14=−1.641346E-05

### 7th Surface

x=0.000000, A4=6.028520E-03, A6=1.695423E-03, A8=1.532929E-04 A10=3.348753E-05, A12=−1.183667E-05, A14=−8.878941E-07

### 8th Surface

x=0.000000, A4=−9.769107E-03, A6=7.211092E-04, A8=1.589253E-04 A10=−1.691148E-05, A12=7.448038E-06, A14=−1.308539E-06

### 9th Surface

x=0.000000, A4=−4.591539E-03, A6=−2.816609E-04, A8=−9.062517E-05 A10=1.811896E-05, A12=1.062153E-06, A14=−1.087231E-06

### 10th Surface

x=0.000000, A4=−3.095969E-02, A6=6.790345E-04, A8=−1.107271E-04 A10=8.870684E-06, A12=1.146161E-07, A14=−1.702592E-07

### 11th Surface

x=0.000000, A4=−2.040695E-02, A6=1.172905E-03, A8=−3.855210E-05 A10=−2.686354E-06, A12=2.397607E-07, A14=−4.582155E-09

### [Conditional Expression Corresponding Value]

Dab/TL=0.376 Conditional expression (1)

La/TL=0.421 Conditional expression (2)

fa/f=0.946 Conditional expression (3)

f12/fa=0.869 Conditional expression (4)

ψ34/ψ=−0.032 Conditional expression (5)

ψ34/ψ5=0.083 Conditional expression (6)

−SAG/Y=0.194 Conditional expression (7)

(Rpa+Rpb)/(Rpa−Rpb)=−0.210 Conditional expression (8)

(Rna+Rnb)/(Rna−Rnb)=−2.053 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 6 is graphs illustrating various aberrations of the imaging lens PL3 according to Example 3. It can be seen in the aberration graphs that in Example 3, various aberrations are successfully corrected and excellent imaging performance is achieved with F number of 2.0 indicating a high brightness and a half angle of view close to 52° that can be regarded as a wide angle of view. All things considered, the excellent imaging performance of the image capturing device CMR including the imaging lens PL3 according to Example 3 can be guaranteed.

### Example 4

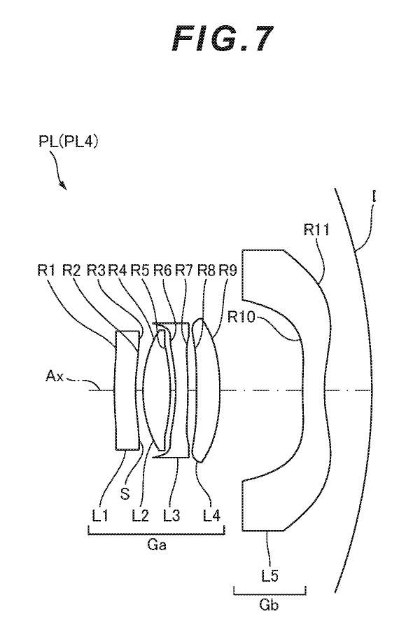

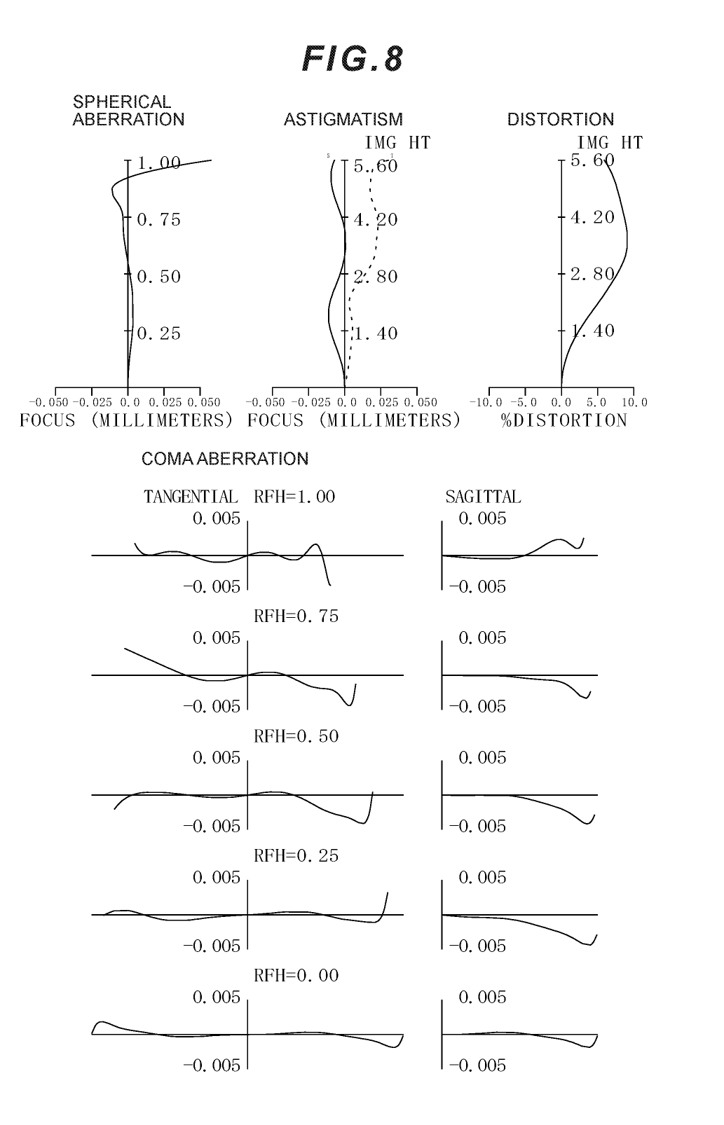

Next, Example 4 according to the present application is described with reference to FIG. 7 and FIG. 8 and Table 4. FIG. 7 is a diagram illustrating a lens configuration of an imaging lens PL (PL4) according to Example 4. The imaging lens PL4 according to Example 4 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL4. Both side lens surfaces of the fifth lens L5 are aspherical surfaces.

In Table 4 below, specification values in Example 4 are listed. The radii of curvature R of 1st to 11th surfaces in Table 4 respectively correspond to reference numerals R1 to R11 denoting 1st to 11th surfaces in FIG. 7. In Example 4, the 1st and 2nd surfaces and the 4th to 11th surfaces are aspherical lens surfaces.

TABLE 4
[Overall specifications]

| | |
|---|---|
| f | 5.507 |
| Fno | 2.0 |
| ω | 50.72° |
| Y | 5.6 |
| TL | 7.199 |
| SAG | −1.032 |

[Lens specifications]

| Surface | | | | |
|---|---|---|---|---|
| number | R | D | nd | νd |
| Object | ∞ | ∞ | | |
| surface | | | | |
| 1* | 7.31862 | 0.59501 | 1.63550 | 23.89 |
| 2* | 5.17463 | 0.10311 | | |
| 3 | ∞ | 0.10311 | | (Aperture stop) |
| 4* | 3.43777 | 0.76255 | 1.53460 | 56.27 |
| 5* | −5.29683 | 0.15297 | | |
| 6* | −4.57762 | 0.34000 | 1.63970 | 23.52 |
| 7* | −11.38758 | 0.24121 | | |
| 8* | −54.00985 | 0.65309 | 1.53500 | 55.73 |
| 9* | −6.25569 | 2.31395 | | |
| 10* | 10.07800 | 0.60907 | 1.53500 | 55.73 |
| 11* | 4.15572 | 1.32557 | | |
| Image | −15.70715 | | | |
| surface | | | | |

### [Aspherical Data]

### 1st Surface

x=0.000000, A4=−2.387322E-02, A6=−1.436190E-03, A8=3.914271E-04 A10=8.281130E-05, A12=−2.687642E-05, A14=1.803017E-06

### 2nd Surface

x=0.000000, A4=−2.480096E-02, A6=−3.792273E-03, A8=2.131974E-03 A10=−1.220031E-06, A12=−7.149198E-05, A14=−1.633753E-08

### 4th Surface

x=0.000000, A4=4.984983E-03, A6=−2.918541E-03, A8=3.324755E-04 A10=2.472443E-04, A12=−8.625314E-05, A14=2.745912E-05

### 5th Surface

x=0.000000, A4=−1.854459E-04, A6=−1.471930E-03, A8=1.349892E-03 A10=−5.490379E-04, A12=5.393806E-04, A14=−1.329893E-04

### 6th Surface

x=0.000000, A4=−5.690548E-04, A6=1.139505E-02, A8=−2.225505E-03 A10=5.323417E-04, A12=6.691553E-04, A14=−3.056800E-04
7th surface
x=9.622055, A4=−2.749508E-03, A6=1.782424E-02, A8=−3.986833E-03 A10=6.598835E-04, A12=3.369884E-04, A14=−1.259715E-04

### 8th Surface

x=10.000000, A4=−2.509257E-02, A6=6.964351E-03, A8=−1.464286E-03 A10=−2.175223E-04, A12=1.508318E-04, A14=5.113899E-06

### 9th Surface

x=5.124974, A4=−8.729154E-03, A6=8.848192E-04, A8=−5.138604E-04 A10=2.017110E-04, A12=−7.766579E-05, A14=1.300850E-05

### 10th Surface

x=10.000000, A4=−3.873464E-02, A6=1.446695E-05, A8=−8.099669E-04 A10=3.268713E-04, A12=−5.502348E-05, A14=2.336810E-06

### 11th Surface

x=0.000000, A4=−2.493198E-02, A6=−1.227018E-04, A8=3.551243E-04 A10=−5.015908E-05, A12=2.883691E-06, A14=−6.137989E-08

### [Conditional Expression Corresponding Value]

Dab/TL=0.321 Conditional expression (1)

La/TL=0.410 Conditional expression (2)

fa/f=0.930 Conditional expression (3)

f12/fa=0.922 Conditional expression (4)

ψ34/ψ=0.04 Conditional expression (5)

ψ34/ψ5=−0.010 Conditional expression (6)

−SAG/Y=0.184 Conditional expression (7)

(Rpa+Rpb)/(Rpa−Rpb)=−0.213 Conditional expression (8)

(Rna+Rnb)/(Rna−Rnb)=−2.344 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 8 is graphs illustrating various aberrations of the imaging lens PL4 according to Example 4. It can be seen in the aberration graphs that in Example 4, various aberrations are successfully corrected and excellent imaging performance is achieved with F number of 2.0 indicating a high brightness and a half angle of view exceeding 50° that can be regarded as a wide angle of view. All things considered, the excellent imaging performance of the image capturing device CMR including the imaging lens PL4 according to Example 4 can be guaranteed.

### Example 5

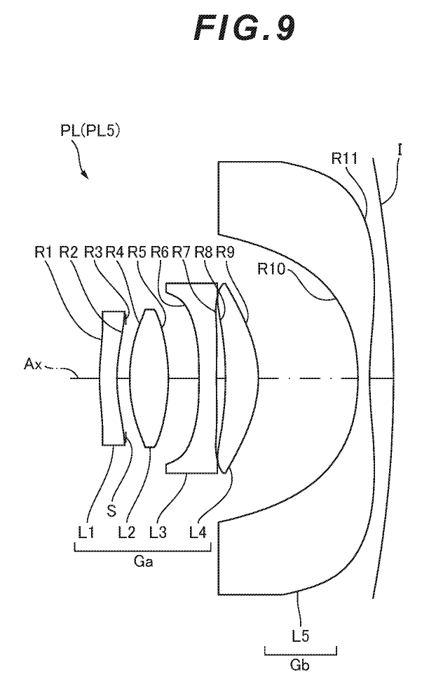

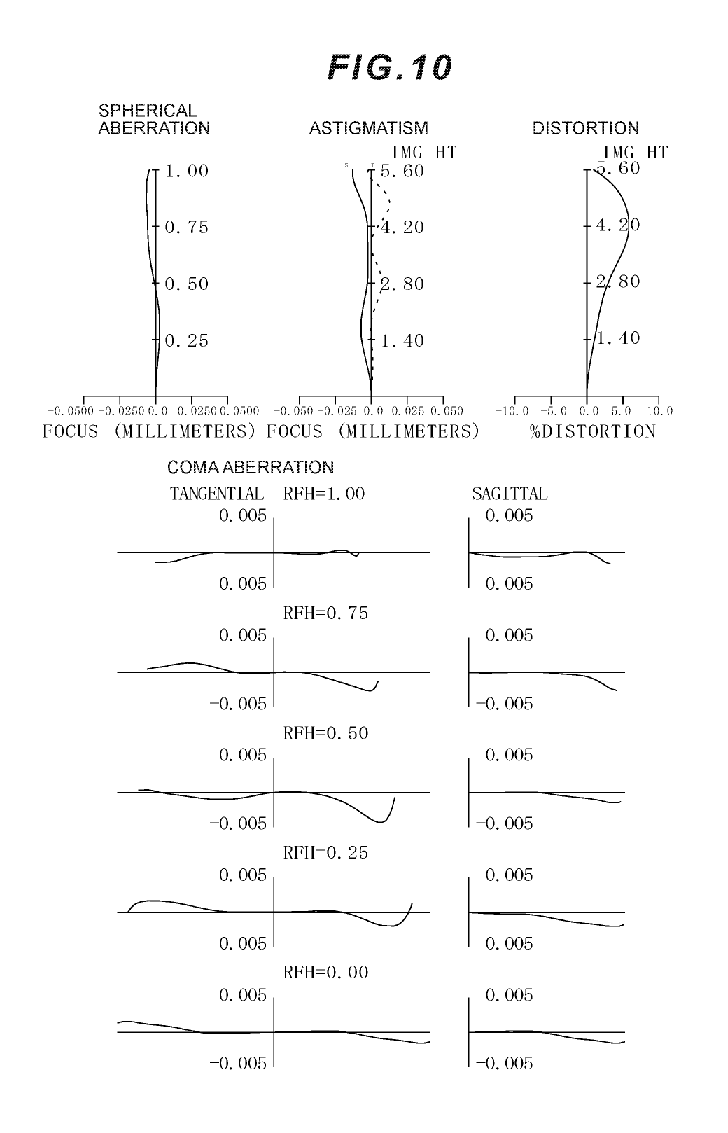

Next, Example 5 according to the present application is described with reference to FIG. 9 and FIG. 10 and Table 5. FIG. 9 is a diagram illustrating a lens configuration of an imaging lens PL (PL5) according to Example 5. The imaging lens PL5 according to Example 5 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL5. Both side lens surfaces of the fifth lens L5 are aspherical surfaces.

In Table 5 below, specification values in Example 5 are listed. The radii of curvature R of 1st to 11th surfaces in Table 5 respectively correspond to reference numerals R1 to R11 denoting 1st to 11th surfaces in FIG. 9. In Example 5, the 1st and 2nd surfaces and the 4th to 11th surfaces are aspherical lens surfaces.

TABLE 5
[Overall specifications]

| | |
|---|---|
| f | 5.511 |
| Fno | 2.0 |
| ω | 48.29° |
| Y | 5.6 |
| TL | 7.553 |
| SAG | −0.527 |

[Lens specifications]

| Surface | | | | |
|---|---|---|---|---|
| number | R | D | nd | νd |
| Object | ∞ | ∞ | | |
| surface | | | | |
| 1* | 5.55000 | 0.44722 | 1.63970 | 23.52 |
| 2* | 3.79297 | 0.22851 | | |
| 3 | ∞ | 0.10000 | | (Aperture stop) |
| 4* | 3.94937 | 0.99167 | 1.53460 | 56.27 |
| 5* | −4.93026 | 0.78867 | | |
| 6* | −18.39046 | 0.44730 | 1.63970 | 23.52 |
| 7* | 15.43578 | 0.23433 | | |
| 8* | −7.85805 | 0.84240 | 1.53500 | 55.73 |
| 9* | −2.90947 | 2.55908 | | |
| 10* | −5.74864 | 0.30000 | 1.53500 | 55.73 |
| 11* | 8.63108 | 0.61442 | | |
| Image | −30.00000 | | | |
| surface | | | | |

[Aspherical Data]

### 1st Surface

x=0.000000, A4=−2.502841E-02, A6=−2.305931E-03, A8=4.719856E-04 A10=1.385292E-04, A12=−5.072484E-05, A14=2.268285E-06

### 2nd Surface

x=0.000000, A4=−2.203598E-02, A6=−4.506885E-03, A8=2.464861E-03 A10=−4.878325E-04, A12=−2.547252E-05, A14=1.843603E-05

### 4th Surface

x=0.000000, A4=3.664588E-03, A6=−9.304148E-04, A8=−5.147925E-05 A10=2.367843E-04, A12=−1.063322E-04, A14=1.701385E-06

### 5th Surface

x=0.000000, A4=−2.960150E-03, A6=1.179240E-03, A8=1.064309E-04 A10=−1.176477E-04, A12=2.288920E-05, A14=−1.553675E-05

### 6th Surface

x=0.000000, A4=−3.407862E-02, A6=4.314519E-03, A8=6.198797E-04 A10=−1.356137E-04, A12=−2.189107E-05, A14=−2.266424E-06
7th surface
x=0.000000, A4=−2.521650E-02, A6=3.179613E-03, A8=3.041810E-04 A10=3.557863E-05, A12=−8.924320E-06, A14=−5.785328E-08

### 8th Surface

x=0.000000, A4=3.155335E-03, A6=−1.446064E-03, A8=2.449335E-04 A10=1.785859E-05, A12=6.689652E-06, A14=−6.916944E-07

### 9th Surface

x=0.000000, A4=7.942085E-03, A6=9.677184E-04, A8=4.079280E-05 A10=−1.965891E-05, A12=−1.150307E-06, A14=4.779823E-07

### 10th Surface

x=0.000000, A4=−1.711710E-02, A6=2.509310E-03, A8=−3.187738E-04 A10=1.866414E-05, A12=−5.543852E-07, A14=2.510314E-09

### 11th Surface

x=0.000000, A4=−9.501268E-03, A6=6.346767E-04, A8=−1.982567E-05 A10=−4.529134E-07, A12=4.247630E-08, A14=−7.573327E-10

### [Conditional Expression Corresponding Value]

Dab/TL=0.339 Conditional expression (1)

La/TL=0.540 Conditional expression (2)

fa/f=0.898 Conditional expression (3)

f12/fa=1.087 Conditional expression (4)

ψ34/ψ=−0.315 Conditional expression (5)

ψ34/ψ5=0.366 Conditional expression (6)

−SAG/Y=0.094 Conditional expression (7)

(Rpa+Rpb)/(Rpa−Rpb)=−0.110 Conditional expression (8)

(Rna+Rnb)/(Rna−Rnb)=0.087 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 10 is graphs illustrating various aberrations of the imaging lens PL5 according to Example 5. It can be seen in the aberration graphs that in Example 5, various aberrations are successfully corrected and excellent imaging performance is achieved with F number of 2.0 indicating a high brightness and a half angle of view exceeding 48° that can be regarded as a wide angle of view. All things considered, the excellent imaging performance of the image capturing device CMR including the imaging lens PL5 according to Example 5 can be guaranteed.

### Example 6

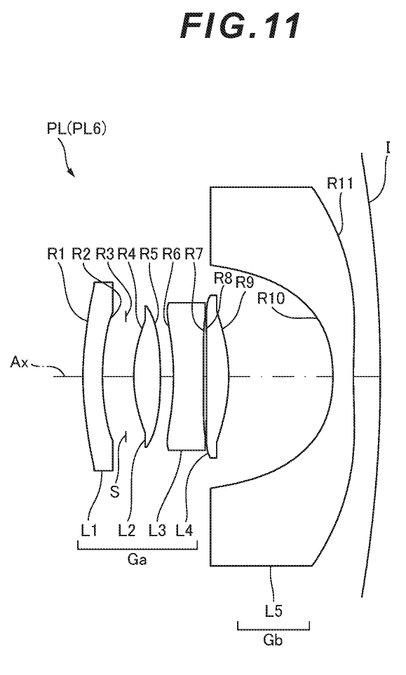

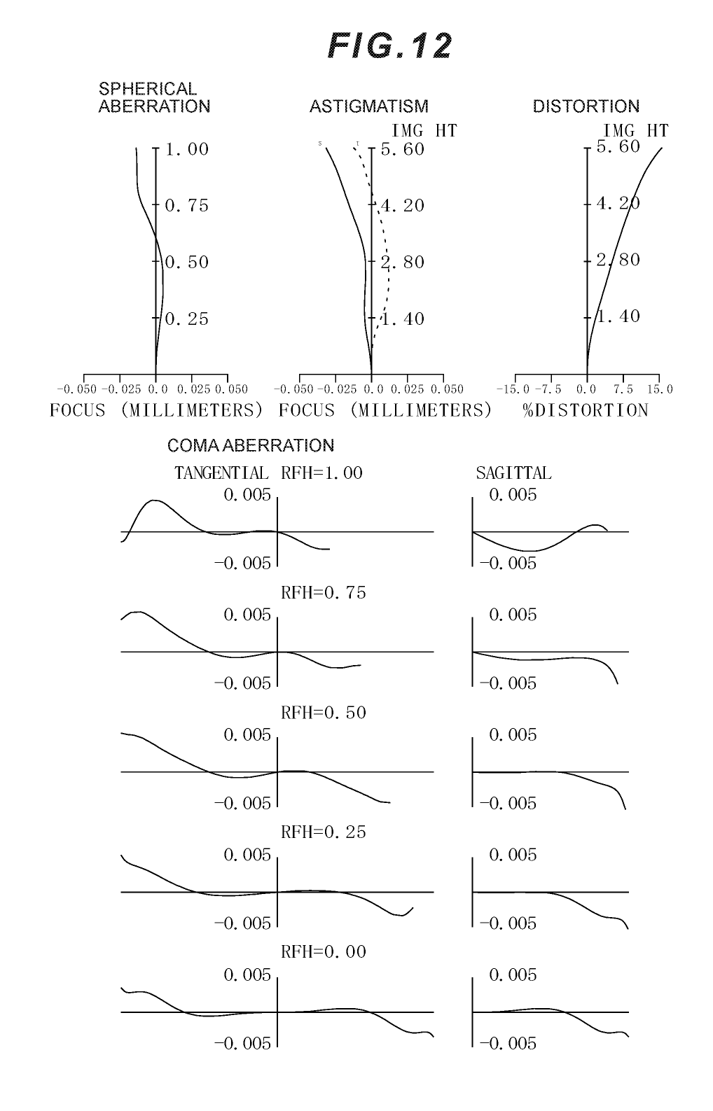

Next, Example 6 according to the present application is described with reference to FIG. 11 and FIG. 12 and Table 6. FIG. 11 is a diagram illustrating a lens configuration of an imaging lens PL (PL6) according to Example 6. The imaging lens PL6 according to Example 6 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL6. Both side lens surfaces of the fifth lens L5 are aspherical surfaces.

In Table 6 below, specification values in Example 6 are listed. The radii of curvature R of 1st to 11th surfaces in Table 6 respectively correspond to reference numerals R1 to R11 denoting 1st to 11th surfaces in FIG. 11. In Example 6, the 1st and 2nd surfaces and the 4th to 11th surfaces are aspherical lens surfaces.

TABLE 6
[Overall specifications]

| | |
|---|---|
| f | 5.514 |
| Fno | 2.0 |
| ω | 45.84° |
| Y | 5.6 |
| TL | 7.610 |
| SAG | −0.476 |

[Lens specifications]

| Surface | | | | |
|---|---|---|---|---|
| number | R | D | nd | νd |
| Object | ∞ | ∞ | | |
| surface | | | | |
| 1* | 6.51930 | 0.50000 | 1.63970 | 23.52 |
| 2* | 5.40288 | 0.59818 | | |
| 3 | ∞ | 0.20484 | | (Aperture stop) |
| 4* | 3.39862 | 0.68182 | 1.53460 | 56.27 |
| 5* | −9.13423 | 0.33230 | | |
| 6* | −7.14112 | 0.76767 | 1.63970 | 23.52 |
| 7* | 234.84213 | 0.07682 | | |
| 8* | 188.35129 | 0.57056 | 1.53500 | 55.73 |
| 9* | −4.15832 | 2.66533 | | |
| 10* | −3.75764 | 0.52546 | 1.53500 | 55.73 |
| 11* | 17.20457 | 0.68708 | | |
| Image | −33.18506 | | | |
| surface | | | | |

### [Aspherical Data]

### 1st Surface

x=0.000000, A4=−1.001359E-02, A6=4.999422E-04, A8=1.931698E-04 A10=−1.771336E-06, A12=−3.939693E-07, A14=−5.620434E-07

### 2nd Surface

x=0.000000, A4=−6.816170E-03, A6=1.384701E-03, A8=5.532027E-04 A10=1.212494E-04, A12=−6.590026E-05, A14=1.611508E-05

### 4th Surface

x=0.000000, A4=−2.983812E-03, A6=−9.036519E-04, A8=−2.758512E-04 A10=2.254453E-04, A12=−1.761604E-04, A14=2.265022E-05

### 5th Surface

x=0.000000, A4=−1.396007E-02, A6=−6.476255E-04, A8=5.743711E-04 A10=−1.258787E-04, A12=−5.973815E-05, A14=7.848080E-06

### 6th Surface

x=0.000000, A4=−8.661583E-03, A6=4.786296E-03, A8=2.698705E-04 A10=−7.837131E-05, A12=−8.275450E-05, A14=2.850157E-05
7th surface
x=0.000000, A4=−3.011969E-03, A6=4.731746E-03, A8=1.572292E-04 A10=−3.477654E-05, A12=−1.269039E-05, A14=1.623061E-06

### 8th Surface

x=0.000000, A4=−5.902356E-03, A6=1.374161E-03, A8=1.826956E-04 A10=−6.276438E-05, A12=1.671556E-05, A14=6.729538E-07

### 9th Surface

x=0.000000, A4=5.180042E-03, A6=−2.409732E-04, A8=8.262618E-05 A10=−1.840318E-05, A12=−1.505452E-06, A14=3.593073E-06

### 10th Surface

x=0.000000, A4=−2.048336E-02, A6=−3.781768E-04, A8=4.566026E-04 A10=−9.613474E-05, A12=9.394189E-06, A14=−7.176287E-07

### 11th Surface

x=0.000000, A4=−1.052248E-02, A6=7.828745E-04, A8=−2.779803E-05 A10=−3.382540E-07, A12=5.284378E-08, A14=−1.046862E-09

### [Conditional Expression Corresponding Value]

Dab/TL=0.350 Conditional expression (1)

La/TL=0.490 Conditional expression (2)

fa/f=0.855 Conditional expression (3)

f12/fa=1.105 Conditional expression (4)

ψ34/ψ=0.275 Conditional expression (5)

ψ34/ψ5=−0.285 Conditional expression (6)

−SAG/Y=0.085 Conditional expression (7)

(Rpa+Rpb)/(Rpa−Rpb)=−0.458 Conditional expression (8)

(Rna+Rnb)/(Rna−Rnb)=−0.941 Conditional expression (9)

As described above, this example satisfies all of the conditional expressions (1) to (9). In this example, the second lens L2 and the third lens L3 serve as the set of lenses, including a positive lens and a negative lens disposed to an image side of the positive lens, and satisfy the conditional expressions (8) and (9).

FIG. 12 is graphs illustrating various aberrations of the imaging lens PL6 according to Example 6. It can be seen in the aberration graphs that in Example 6, various aberrations are successfully corrected and excellent imaging performance is achieved with F number of 2.0 indicating a high brightness and a half angle of view exceeding 45° that can be regarded as a wide angle of view. All things considered, the excellent imaging performance of the image capturing device CMR including the imaging lens PL6 according to Example 6 can be guaranteed.

### Example 7

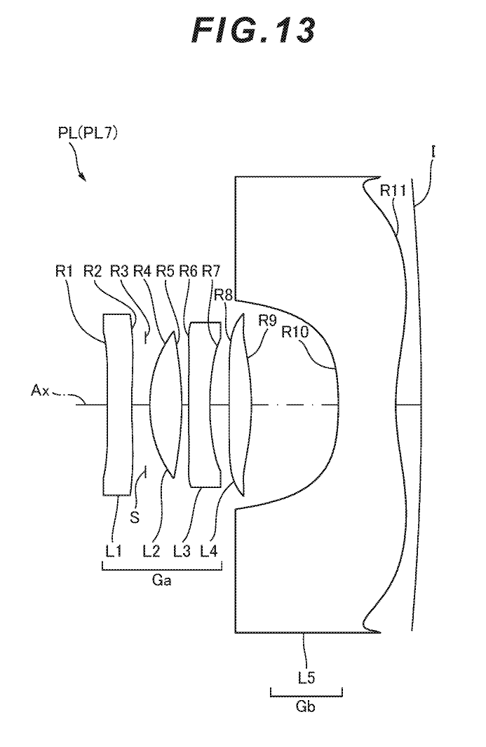

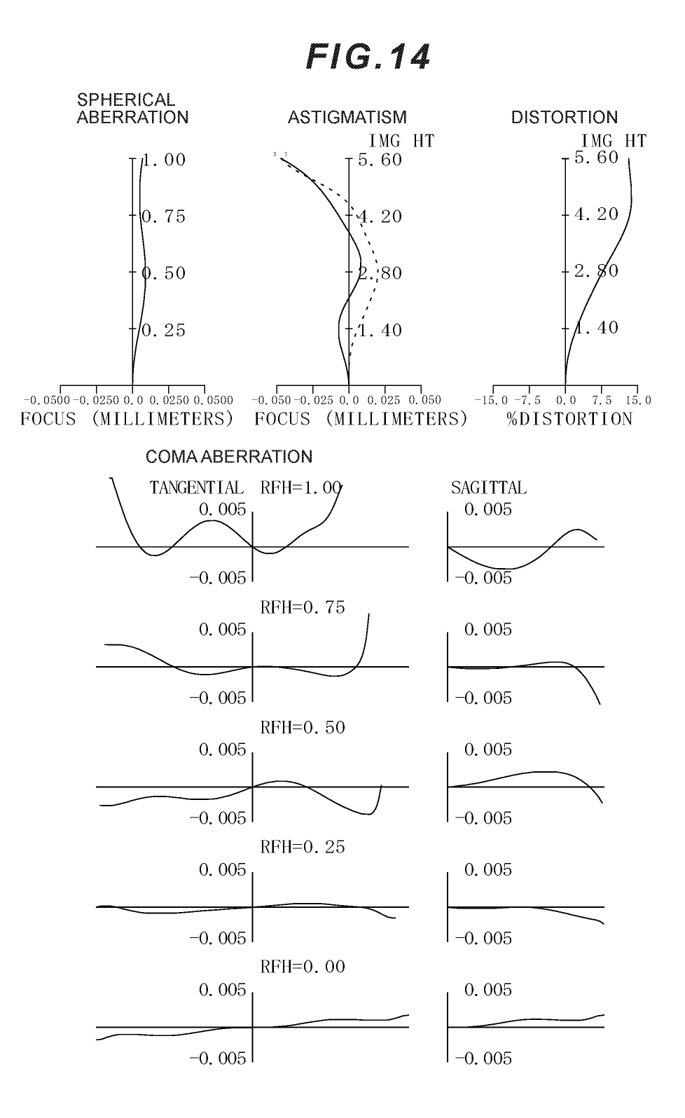

Next, Example 7 according to the present application is described with reference to FIG. 13 and FIG. 14 and Table 7. FIG. 13 is a diagram illustrating a lens configuration of an imaging lens PL (PL7) according to Example 7. The imaging lens PL7 according to Example 7 includes in order from an object along the optical axis Ax: a front group Ga including four lenses L1 to L4; and a back group Gb including a single lens L5. The image surface I of the imaging lens PL1 is curved into a spherical shape to have a concave surface facing the object.

The front group Ga includes in order from the object along the optical axis Ax: the first lens L1 having negative refractive power; the second lens L2 having positive refractive power; the third lens L3 having negative refractive power; and the fourth lens L4 having positive refractive power. Both side lens surfaces of the first lens L1 are aspherical surfaces. An aperture stop S is provided close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces.

The back group Gb includes the fifth lens L5 having negative refractive power, and is disposed while being separated from the front group Ga by the longest distance in the imaging lens PL7. Both side lens surfaces of the fifth lens L5 are aspherical surfaces.

In Table 7 below, specification values in Example 7 are listed. The radii of curvature R of 1st to 11th surfaces in Table 7 respectively correspond to reference numerals R1 to R11 denoting 1st to 11th surfaces in FIG. 13. In Example 7, the 1st and 2nd surfaces and the 4th to 11th surfaces are aspherical lens surfaces.

TABLE 7
[Overall specifications]

| | |
|---|---|
| f | 5.512 |
| Fno | 2.0 |
| ω | 43.82° |
| Y | 5.6 |
| TL | 7.401 |
| SAG | −0.251 |

[Lens specifications]

| Surface | | | | |
|---|---|---|---|---|
| number | R | D | nd | νd |
| Object | ∞ | ∞ | | |
| surface | | | | |
| 1* | 33.01139 | 0.57861 | 1.63970 | 23.52 |
| 2* | 13.83405 | 0.32371 | | |
| 3 | ∞ | 0.10002 | | (Aperture stop) |
| 4* | 3.23320 | 0.75321 | 1.53460 | 56.27 |
| 5* | −6.36441 | 0.16045 | | |
| 6* | 27.85932 | 0.50000 | 1.63970 | 23.52 |
| 7* | 5.71468 | 0.45538 | | |
| 8* | 260.47315 | 0.52488 | 1.53500 | 55.73 |
| 9* | −6.01846 | 2.04696 | | |
| 10* | −8.10042 | 1.35412 | 1.53500 | 55.73 |
| 11* | 5.31469 | 0.60380 | | |
| Image | −62.47471 | | | |
| surface | | | | |

### [Aspherical Data]

### 1st Surface

x=0.000000, A4=−1.883450E-02, A6=7.137414E-04, A8=7.225372E-05 A10=1.926184E-05, A12=−2.055988E-06, A14=−2.561793E-07

### 2nd Surface

x=0.000000, A4=−1.465572E-02, A6=2.160557E-04, A8=2.087663E-04 A10=1.763118E-05, A12=−3.023191E-06, A14=−5.430090E-07

### 4th Surface

x=0.000000, A4=8.993747E-03, A6=−3.497801E-04, A8=−9.896817E-05 A10=5.005174E-05, A12=2.136173E-05, A14=−1.394857E-05

### 5th Surface

x=0.000000, A4=1.018827E-02, A6=−9.869783E-04, A8=−2.634481E-04 A10=2.822208E-05, A12=2.478811E-05, A14=−8.818013E-06

### 6th Surface

x=0.000000, A4=−1.051070E-02, A6=2.052148E-03, A8=−3.754909E-04 A10=−5.765704E-05, A12=5.511299E-05, A14=−6.451139E-09
7th surface
x=0.000000, A4=−6.081273E-03, A6=3.996498E-03, A8=7.742946E-04 A10=−1.281024E-04, A12=−6.367530E-05, A14=3.276315E-05

### 8th Surface

x=0.000000, A4=2.015804E-03, A6=1.365154E-03, A8=3.878255E-04 A10=8.531104E-05, A12=−3.059463E-05, A14=2.439206E-06

### 9th Surface

x=0.000000, A4=3.398830E-04, A6=1.200685E-03, A8=2.282118E-04 A10=−9.388958E-05, A12=7.034690E-05, A14=−7.905999E-06

### 10th Surface

x=0.000000, A4=−3.154014E-02, A6=−1.149464E-03, A8=−1.119232E-04 A10=3.301650E-05, A12=−6.696658E-08, A14=−2.905879E-06

### 11th Surface

x=0.000000, A4=−1.319128E-02, A6=6.795618E-04, A8=−1.913142E-05 A10=−2.096037E-07, A12=1.691261E-08, A14=−1.985748E-10

### [Conditional Expression Corresponding Value]

Dab/TL=0.277 Conditional expression (1)

La/TL=0.459 Conditional expression (2)

fa/f=0.860 Conditional expression (3)

f12/fa=0.967 Conditional expression (4)

ψ34/ψ=0.046 Conditional expression (5)

ψ34/ψ5=−0.0049 Conditional expression (6)

−SAG/Y=0.045 Conditional expression (7)

(Rpa+Rpb)/(Rpa−Rpb)=−−0.326 Conditional expression (8)

(Rna+Rnb)/(Rna−Rnb)=−1.516 Conditional expression (9)

As described above, this example satisfies all of the conditional expressions (1) to (8). In this example, the second lens L2 and the third lens L3 serve as the set of lenses, including a positive lens and a negative lens disposed to an image side of the positive lens, and satisfy the conditional expression (8) only.

FIG. 14 is graphs illustrating various aberrations of the imaging lens PL7 according to Example 7. It can be seen in the aberration graphs that in Example 7, various aberrations are successfully corrected and excellent imaging performance is achieved with F number of 2.0 indicating a high brightness and a half angle of view close to 44° that can be regarded as a wide angle of view. All things considered, the excellent imaging performance of the image capturing device CMR including the imaging lens PL7 according to Example 7 can be guaranteed.

With Examples described above, an imaging lens having small size with a short total length and excellent imaging performance with a wide angle of view and high brightness, and an image capturing device including the same can be implemented.

In Examples described above, the image surface I of the imaging lens PL is curved to have a spherical concave surface facing the object. However, this should not be construed in a limiting sense. For example, another curved shape such as an aspherical curved shape may be employed.

The bonded-multilayer diffractive optical element may be provided on at least one of the lens surfaces of the first lens L1, the second lens L2, the third lens L3, the fourth lens L4, and the fifth lens L5 in Examples described above.

In Examples described above, a parallel flat plate including a cover glass of the image sensor or the like may be disposed between the fifth lens L5 and the image surface I.

In Examples described above, the aperture stop S, disposed close to the first lens L1, is preferably disposed close to an image-side lens surface of the first lens L1 for the sake of aberration correction. The aperture stop may not be provided as a component, and its function may be achieved with a frame of a lens.

### EXPLANATION OF NUMERALS AND CHARACTERS

CMR image capturing device
SR image sensor
PL Imaging lens
Ga front group
Gb back group
L1 first lens
L2 second lens
L3 third lens
L4 fourth lens
L5 fifth lens
S aperture stop
I image surface

1. An imaging lens having an image surface curved to have a concave surface facing an object,
the imaging lens consisting of, in order from the object: a front group including four lenses; and a back group including a single lens,
wherein a following conditional expression is satisfied
0.25<Dab/TL<0.50
0.30<La/TL<0.55
where,
Dab denotes a distance between the front group and the back group on the optical axis,
La denotes a length of the front group on the optical axis, and
TL denotes a total length of the imaging lens (a distance between a vertex of a lens surface closest to the object and an axial image point corresponding to an infinite distant object).

2. The imaging lens according to claim 1, wherein a following conditional expression is satisfied
0.85<fa/f<1.10
where,
fa denotes a focal length of the front group, and
f denotes a focal length of the imaging lens.

3. The imaging lens according to claim 2, wherein the front group consists of: a first lens having positive or negative refractive power; a second lens having positive refractive power; a third lens having negative refractive power; and a fourth lens having positive refractive power which are disposed in order from the object, and
the back group consists of a fifth lens having negative refractive power.

4. The imaging lens according to claim 3, wherein a following conditional expression is satisfied
0.7<f12/fa<1.9
where,
f12 denotes a combined focal length of the first lens and the second lens, and
fa denotes the focal length of the front group.

5. The imaging lens according to claim 3, wherein a following conditional expression is satisfied
−0.5<ψ34/ψ<0.5
where,
ψ34 denotes combined refractive power of the third lens and the fourth lens, and
ψ denotes refractive power of the imaging lens.

6. The imaging lens according to claim 3, wherein a following conditional expression is satisfied
−0.8<ψ34/ψ5<1.5
where,
ψ34 denotes combined refractive power of the third lens and the fourth lens, and
ψ5 denotes refractive power of the fifth lens.

7. The imaging lens according to claim 3, wherein a following conditional expression is satisfied
0.03<−SAG/Y<0.30
where,
Y denotes a maximum image height of the imaging lens, and
SAG denotes an amount of curvature of the image surface in an optical axis direction at the maximum image height.

8. The imaging lens according to claim 3, wherein the four lenses in the front group and the single lens in the back group include a set of lenses, including a positive lens and a negative lens disposed to an image side of the positive lens, satisfying following conditional expressions
−1.0<(Rpa+Rpb)/(Rpa−Rpb)<0.5
(Rna+Rnb)/(Rna−Rnb)<0.1
where,
Rpa denotes a radius of curvature of an object-side lens surface of the positive lens,
Rpb denotes a radius of curvature of an image-side lens surface of the positive lens,
Rna denotes a radius of curvature of an object-side lens surface of the negative lens, and
Rnb denotes a radius of curvature of an image-side lens surface of the negative lens.

9. An image capturing device comprising: an imaging lens with which an image of an object is formed on an image capturing surface of an image sensor; and
the image sensor configured to obtain the image of the object formed on the image capturing surface, wherein
the image capturing surface of an image sensor is curved to have a concave surface facing the object, the imaging lens has an image surface curved along the image capturing surface, and
the imaging lens is the imaging lens according to claim 3.
